(19) United States
(12) Patent Application Publication
(10) Pub. No.: US 2025/0388764 A1
(43) Pub. Date: Dec. 25, 2025

(54) HYBRIDIZED GRAPHENE FAMILY / METALLIC ORGANIC FRAMEWORKS NANOCOMPOSITE COMPOSITION, AND USE AS ADDITIVE FOR INTUMESCENT COATINGS

(71) Applicant: Zentek Ltd, Guelph (CA)

(72) Inventors: Colin VAN DER KUUR, Kelowna (CA); SEYYEDARASH HADDADI, Guelph (CA)

(21) Appl. No.: 18/851,046

(22) PCT Filed: Mar. 27, 2023
(86) PCT No.: PCT/CA2023/050408

§ 371 Date: Sep. 25, 2024

Related U.S. Application Data
(60) Provisional application No. 63/323,716, filed on Mar. 25, 2022.

(51) Int. Cl. C09D 5/18; C09D 7/62

(52) U.S. Cl. CPC C09D 5/185; C09D 7/62

(57) ABSTRACT

A hybridized graphene oxide and metallic organic framework nanocomposite, and an intumescent coating composition comprising the nanocomposite as an additive.

### TECHNICAL FIELD OF THE INVENTION

The present invention relates to graphene family based compositions and their uses. The present invention further relates to intumescent coatings for imparting fire-retardant properties to a substrate, and more particularly to additives to enhance such fire-retardant properties.

### BACKGROUND OF THE INVENTION

It is known in the art of passive fire protection to apply intumescent coatings to substrates such as metals and woods, and intumescent materials can also be added to polymers and plastic nanocomposites which can be used to fire-proof putty and pipe. Intumescent materials swell when exposed to heat, with subsequent volume increase but density decrease. Various resin-based systems have been proposed for this purpose. Depending on type, intumescent coatings may reduce flame spread rate, resist ignition and/or insulate the coated substrate.

However, it has been found that neat resin coatings provide only limited protection to underlying metallic substrates before their thermal decomposition at around 300 degrees C. In response, it is known to incorporate various additives into an intumescent coating to enhance the fire-retardant properties of the coating, such as for example ammonium polyphosphate. Numerous such additives have been identified and are commercially available. Limiting factors of known additives include the mechanical performance and dimensional stability of the char, the release of noxious fumes, the transmission of heat through the coating and the fact that many materials are considered either hazardous to the environment or irritants.

A need exists for improved additives to enhance fire-retardant properties of intumescent coatings that address at least one of these limiting factors.

### SUMMARY OF THE INVENTION

A novel composition has been invented which can be used with intumescent coatings but potentially in other applications. According to a first broad aspect of the present invention there is a provided a hybridized graphene family member and metallic organic frameworks (MOF) nanocomposite composition.

In some exemplary embodiments of the first broad aspect, the composition comprises a ratio of graphene family member to metallic organic frameworks of 1:1 to 1:3. Exemplary compositions may be formed by adding Ce³⁺ in concentrations of 4.5-9 g per 1 g of the graphene family member at pH 10 under stirring for 1-3 hours. Alternatively, instead of Ce³⁺ some exemplary compositions may be formed by adding Zn²⁺ or La³⁺.

While graphene oxide (GO) is one preferred member of the graphene family, and in some embodiments may take the form of nanosheets, other members of the graphene family may have utility in embodiments of the present invention, such as for example graphite oxide, graphene quantum dot and partially oxidized graphene nanoparticles. This composition may be referred to herein as a hybridized graphene (or GO)/MOF nanocomposite.

It is known to synthesize MOF-decorated GO by (1) doping of Ce³⁺ on GO nanosheets, (2) removing any undoped/excess amount by centrifugation, and (3) adding an organic component to the Ce³⁺ doped GO nanosheets at low concentration, thus forming some MOF nanorods on the GO nanosheets at low amounts. However, in the present invention, Ce³⁺ is added in higher concentrations (4.5-9 g per 1 g GO) to the GO nanosheets at pH 10 under stirring for 1-3 hours, although as noted above Zn²⁺ or La³⁺ may be substituted for the Ce³⁺. The organic component is also added to the previous suspension in a stoichiometric ratio without any washing steps. Then, MOF nanorods are grafted on the surface of GO nanosheets and also between GO nanosheets with a ratio of GO:MOF of 1:1 to 1:3. This synthesis is a one-pot synthesis method with no extra washing step. In most prior art publications, GO nanosheets are merely decorated with MOF, thus, the final nanostructure is primarily GO with some MOFs on the surface. In the present invention a GO/MOF hybridized nanocomposite is formed with a ratio of GO:MOF of around 1:2 to 1:3. In GO/MOF hybridized nanocomposites, the amount of MOF is greater than GO nanosheets, thus, you cannot decorate all of the MOFs on the surface of the GO nanosheets. The reaction of excess amounts of Ce³⁺ and organic components can be done in the media between GO nanosheets. In fact, GO nanosheets are saturated first with Ce³⁺ while the extra amount of Ce³⁺ is still in the solution (no centrifugation and washing to get rid of them). Further, due to the high concentration of an organic component, organic molecules react with both doped and excess amounts of Ce³⁺. Thus, there is a mixture of MOF and MOF-decorated GO nanosheets, fully decorated GO nanosheets with MOF and individual (unbonded) MOF around decorated GO nanosheets. FIG. 1 illustrates a GO nanosheet and a GO/MOF hybridized nanocomposite.

Graphene oxide enhances the char material to improve mechanical performance. Graphene oxide, when reduced to reduced graphene oxide, emits water and other oxygenated small molecules which can reduce the spread of flame while also decreasing the density of the coating as the steam percolates through the material. The metallic organic framework is known to have very high surface area and high porosity with a large capacity for gas absorption, thus fumes that may be generated through the char burning can be adsorbed thus reducing noxious vapors produced by the flames. Reduced graphene oxide may also create an impervious barrier to block the spread of flame through the material and produce an oxygen barrier to restrict combustion. Finally, with the enhancement of the traditional intumescent coating material, more environmentally and bio-friendly materials may be used successfully with similar performance to banned substances like polybrominated biphenyls (PBB) and polybrominated diphenyl ether (PBDE).

It has been observed that hybridized GO/MOF nanocomposite appears to increase the performance of both the graphene oxide and the metallic organic framework material, keeping the graphene oxide from agglomerating while also protecting the metallic organic framework material from physical and environmental damage. The GO nanosheets act like supports for the MOFs to protect them from thermal and mechanical stresses. Also, the propagation of MOF nanorods in forms of aggregations and agglomerations may occur in the absence of the GO nanosheets.

According to a second broad aspect of the present invention, there is provided an intumescent coating composition comprising a hybridized graphene oxide and metallic organic framework nanocomposite additive.

In some exemplary embodiments of the second broad aspect, the composition comprises melamine-ammonium polyphosphate, pentaerythritol, acrylic resin/solvent, tannic acid, and the additive. The composition may comprise 50-60 wt. % of the melamine-ammonium polyphosphate, 5-10 wt. % of the pentaerythritol, 10-20 wt. % of the acrylic resin/solvent, 2-5 wt. % of the tannic acid, and 0.1-1.5 wt. % of the hybridized additive.

In some exemplary compositions the additive is formed from graphene oxide nanosheets and metallic organic framework nanorods. The graphene oxide nanosheets preferably have an average lateral size of 500 nm-20 μm, most preferably greater than 5 μm, while the metallic organic framework nanorods are preferably about 80-180 nm in average diameter.

In some exemplary embodiments, the additive is blended into a polymer or an elastomer, which may produce more durable fire-resistant polymers or elastomers.

Some exemplary compositions may further comprise: the additive; ammonium polyphosphate; and a material selected from the group consisting of graphite, expandable graphite, expanded graphite and silicon, to produce a material that may form a hardened char when exposed to high temperatures for a more durable and fire-resistant coating, such as for exterior doors and polymers, which may address higher temperatures such as those produced by lithium ion batteries.

According to a third broad aspect of the present invention, there is provided a method of manufacturing an intumescent coating composition comprising the steps of: a. forming a graphite powder suspension; b. adding KMnO₄ to the graphite powder suspension to form a mixture while decreasing the temperature of the mixture; c. adding distilled water to the mixture; d. adding H₂O₂ to the mixture to form graphene oxide nanosheets in a nanosheet suspension; e. washing the graphene oxide nanosheet suspension to obtain washed graphene oxide nanosheets; f. dispersing the washed graphene oxide nanosheets in deionized water to form a GO/DI suspension; g. adding CeNO₃ to the GO/DI suspension to form a GO/DI/CeNO₃ suspension; h. dissolving benzene-1,3,5-tricarboxylic acid in ethanol to form a solution; i. adding the solution to the GO/DI/CeNO₃ suspension to form hybridized graphene oxide and metallic organic framework nanocomposites; j. collecting the hybridized graphene oxide and metallic organic framework nanocomposites and exchanging the deionized water and the ethanol in the hybridized graphene oxide and metallic organic framework nanocomposites with xylene; and k. mixing the washed hybridized graphene oxide and metallic organic framework nanocomposites into an intumescent base material.

In some exemplary embodiments of the third broad aspect, the graphite powder suspension is formed from graphite powder and a solution of H₂SO₄ and H₃PO₄. The graphite powder suspension is preferably sonicated in a bath sonicator between steps a. and b. The mixture of step b. is preferably stirred, followed by bath sonication. The distilled water is preferably at 2-5 degrees C.

In some exemplary embodiments, bath sonication after step d. is used to accelerate separation of the graphene oxide nanosheets. The washing of step e. preferably comprises washing the graphene oxide nanosheet suspension a plurality of times with 1 M HCl and a plurality of times with an 8:2 v/v water/ethanol mixture. Most preferably, bath sonication occurs between the HCl and water/ethanol mixture washings to accelerate impurity removal between the graphene oxide nanosheets.

Some exemplary methods comprise washing the hybridized graphene oxide and metallic organic framework nanocomposites with xylene via centrifugation.

The intumescent base material preferably comprises melamine-ammonium polyphosphate, pentaerythritol, acrylic resin/solvent, and tannic acid.

The base intumescent material described herein as enhanced with the hybridized GO/MOF nanocomposite can also be added in various proportions to both elastomers and polymers such as epoxy and acrylic resins, polyurethane, polyolefins, PVC, silicone-based rubbers, etc., to produce materials with enhanced protective barriers compared to the base fire resistance.

The GO/MOF enhanced material can also be added in a variety of proportions to graphite and expanded graphite to produce a hard char intumescent material that may have further mechanical and adsorption performance. This material may manifest superior heat and mechanical performance for exterior walls, and when added to a polymers like epoxy and acrylic resins, polyurethane, polyolefins, PVC, silicone-based rubbers, and others, a non-metallic material potentially suitable to protect lithium ion batteries.

According to a fourth broad aspect of the present invention, there is provided a use of an intumescent composition comprising a hybridized graphene oxide and metallic organic framework nanocomposite additive as a fire-retardant coating for a substrate.

In some exemplary embodiments of the fourth broad aspect, the substrate is selected from metal, polymer nanocomposites and wood. The composition may be applied to the substrate using a film applicator. In exemplary embodiments, the composition is allowed to dry on the substrate before exposing the substrate to fire.

In some exemplary embodiments the porosity of the metallic organic framework in the composition allows adsorption of combustion gases that are generated due to the fire event.

The composition also comprises graphene oxide, such that in some exemplary embodiments the graphene oxide is reduced to reduced graphene oxide (rGO) which may increase its barrier properties reducing the spread of flames and restricting oxygen supply. The reducing of the graphene oxide in the presence of flames may also generate water and vapor thereby reducing spread of the flames, absorb energy through conversion of the water to steam, and due to the steam increase volume of char formed. The presence of graphene oxide may also enhance mechanical performance of char thereby extending fire barrier duration.

While use of the novel composition in fire-retardant coating is a focus of the within description, it is noted that the hybridized GO/MOF nanocomposite composition may have utility in other areas such as sensors, catalysts, absorbents, carbon capture, and others.

A detailed description of exemplary embodiments of the present invention is given in the following. It is to be understood, however, that the invention is not to be construed as being limited to these embodiments. The exemplary embodiments are directed to particular applications of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments of the present invention:

FIG. 1 illustrates a GO nanosheet and a GO/MOF hybridized nanocomposite.

FIG. 2 is FE-SEM images of GO/MOF hybridized nanocomposites at different magnifications.

FIG. 3 is a graph showing EDS results of the synthesized GO/MOF hybridized nanocomposites.

FIG. 4 is a graph showing FT-IR spectra of GO nanosheets and GO/MOF hybridized nanocomposites.

FIG. 5 is a graph showing XRD patterns of GO nanosheets and GO/MOF hybridized nanocomposites.

FIG. 6 shows images of the appearance of coated plates with different intumescent coatings.

FIG. 7 are graphs showing the temperature profile of coated samples as a function of time.

FIG. 8 shows images of the appearance of coated mild steel plates with the neat resin and intumescent coating with no GO/MOF nanocomposites.

FIG. 9 shows images of the appearance of coated mild steel plates with intumescent coatings filled with 0.25, 0.5, and 1.5 wt. % GO/MOF nanocomposites.

FIG. 10 shows images of plywood coated with R and P compositions at 0.5 and 0.25 concentrations, with GO/MOF additive.

FIG. 11 shows images of plywood coated with R and P compositions at 0.5 and 0.25 concentrations, without GO/MOF additive.

FIG. 12 shows an image of plywood coated with commercially available INSL-X™ intumescent paint.

FIG. 13 shows the plywood of FIG. 10 after application of propane flame.

FIG. 14 shows the plywood of FIG. 11 after application of propane flame.

FIG. 15 shows the plywood of FIG. 12 after application of propane flame.

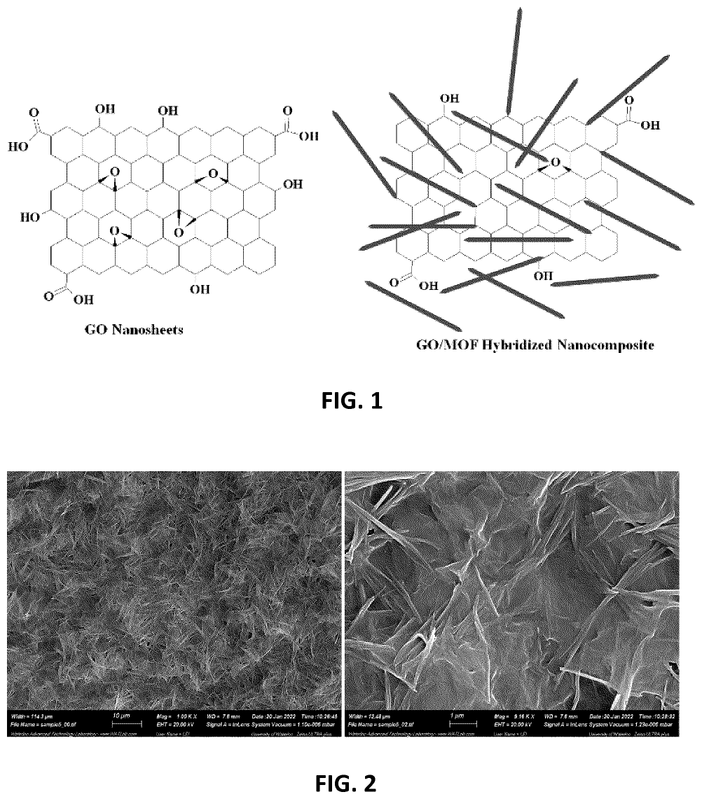

Exemplary embodiments will now be described with reference to the accompanying drawings.

### DETAILED DESCRIPTION OF EXEMPLARY EMBODIMENTS

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

The present invention is directed to a novel hybridized graphene family and metallic organic frameworks (MOF) nanocomposite material, which among other potential uses may be used as an additive in intumescent coatings for a target substrate to increase the fire-retardant properties of the substrate. Graphene oxide (GO), a member of the graphene family, is a single monomolecular layer of graphite with various oxygen-containing functionalities. Metallic organic frameworks (MOFs) are compounds consisting of metal ions or clusters coordinated to organic ligands, and are often porous, essentially a coordination network with organic ligands potentially containing voids. It is believed that creating the hybridized GO/MOF nanocomposite may preserve and disperse the MOFs in many situations, capturing the known advantages arising from the high surface area of the MOFs. Without being limited by theory, it is believed that the high specific volume and large specific surface area of MOFs and the diversity of functional groups of GO nanosheets enable the hybridized GO/MOFs to make a better barrier between the flame and the substrate, and possibly also adsorbing combustion products generated by the flame. This is believed to lead to a lower temperature and a more stable ash framework forming on the surface of a substrate. Also, it is believed that the reduction of GO nanosheets to form the more stable reduced GO (rGO) may adsorb a portion of the heat and release some inflammable oxygenated small molecules such as water, generating more porosity inside the coating and reducing the temperature of the coating.

Following are examples of the formation and use of an exemplary additive and coating in accordance with one embodiment of the present invention (Example 1) and test results demonstrating the effect of GO/MOF enhanced material in intumescent coatings including formulations in accordance with embodiments of the present invention (Example 2).

### Example 1

### Synthesis of Graphene Oxide (GO)

To begin, 1 g graphite powder was soaked in a solution of 30 mL H₂SO₄ (98%) and 5 mL H₃PO₄ (85%) under a fume hood in an Erlenmeyer flask under stirring conditions at 50 degrees C. and 300 rpm for 18 hours. The resultant suspension was then sonicated 3 times every 6 hours using a bath sonicator for 30 minutes each time. Following this, 6 g KMnO₄ was added gradually to the suspension. An ice/water bath was used to decrease the temperature of the suspension during the exothermic oxidation reactions. The suspension was kept under continuous stirring for up to 12 hours at 35 degrees C. Bath sonication (for 15-30 minutes) was used 3 times after 8 hours of stirring.

Next, 100 mL of cold distilled water (at 2-5 degrees C.) was added to the previous mixture. In this stage, the temperature of the mixture was kept below 5 degrees C. using an ice bath. H₂O₂ (at 30%) was then added drop-by-drop to the diluted mixture until the color of the mixture changed from dark brown to yellow. Before purification, a 30-minute bath sonication of the mixture was used to accelerate the separation of exfoliated GO nanosheets from each other.

The final suspension was washed 3 times with HCl (1 M) and three times with a mixture of water/ethanol (8:2 v/v). Bath sonication (30 minutes) was used between the purification steps to accelerate the removal of impurities intercalated between the GO layers. The pH of the sample was adjusted to 3-4 during the centrifuging by 1 M KOH solution for better sedimentation. The final GO nanosheets with 33% oxygen content were dispersed in distilled water and stored for the next step in the exemplary composition formation.

### Hybridized GO/MOF Nanocomposites

To synthesize the exemplary GO/MOF hybridized nanocomposites, the 1 g GO nanosheets were dispersed in 200 mL deionized water using probe sonication for 30 minutes. The pH of the suspension was then adjusted to 10 using NaOH (1 M). Next, 5 g CeNO₃ was added to the suspension under stirring for 1 hour at 45 degrees C. In a second container, 3 g benzene-1,3,5-tricarboxylic acid was dissolved in 50 mL ethanol at 65 degrees C. for 30 minutes. This second solution was then added drop-by-drop to the first suspension under stirring at 65 degrees C. for 6 hours. Finally, the GO/MOF hybridized nanocomposites were collected by centrifuge and washed three times with a water/ethanol mixture (1:2 v/v). To exchange water and ethanol with xylene, the collected sediments were washed two times with xylene via centrifugation. In some embodiments, tannic acid may be functionalized to the GO nanosheets, which may improve barrier performance.

### Formulation of Intumescent Coatings

The formulation of the final intumescent coatings was based on tannic acid (2-5 wt. %) (the tannic acid an organic compound that produces ash), melamine-ammonium polyphosphate (50-60 wt. %) (melamine acting as a binder and stabilizer for the ash, while the ammonium polyphosphate is the primary component that expands in the intumescent material), pentaerythritol (5-10 wt. %) (acting as a cross-linking agent for ashes, which produces a thick carbon barrier upon heating and release small molecules such as CO₂ and H₂O), acrylic resin/solvent (10-20 wt. %), and GO/MOF hybridized nanocomposites (0.1-1.5 wt. %). The specific component percentages are selected for a particular application, and thus may differ for other applications. Intumescent coatings with and without GO/MOF hybridized nanocomposites were fabricated for testing, using direct mixing of flame-retardant additives with proper content of solvent to control the viscosity of blends via mechanical mixing. The final blends were applied on metallic and wood substrates using a film applicator at different thicknesses.

### Characterization of GO/MOF Hybridized Nanocomposites

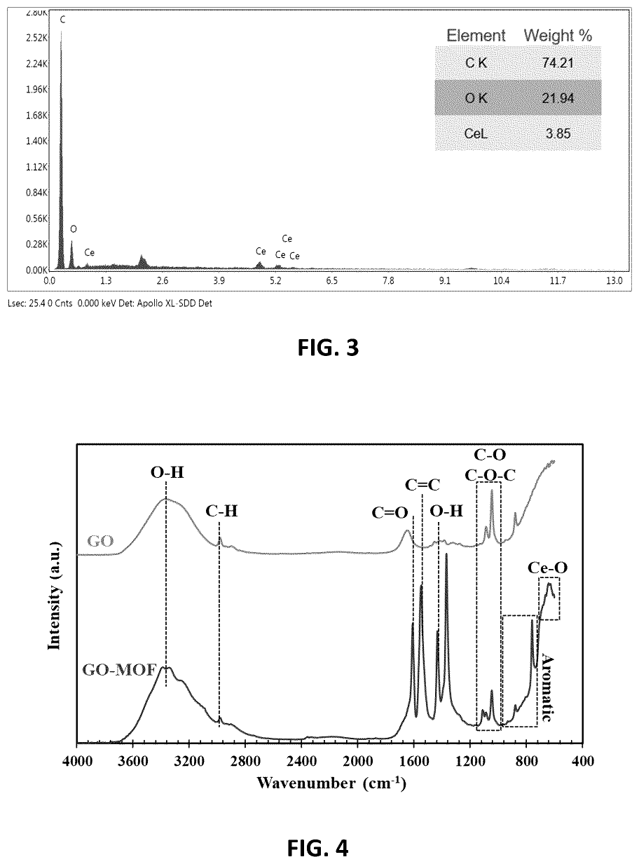

FE-SEM-EDS: FE-SEM and EDS analyses were used to assess the morphology and elemental composition of synthesized GO/MOF hybridized nanocomposites. FIG. 2 shows FE-SEM images of GO/MOF hybridized nanocomposites at different magnifications. As is clear in FIG. 2, MOF nanorods with an average diameter of 80-180 nm were synthesized uniformly on the surface of GO nanosheets with no aggregations. Also, the single-layered GO nanosheets are clearly shown between MOF nanorods with an average lateral size of 5-20 μm. FIG. 3 presents the EDS spectrum of the synthesized GO/MOF hybridized nanocomposites. The oxygen content of GO nanosheets was obtained around 35 wt. % while EDS showed that GO/MOF hybridized nanocomposites have 21.9 wt. % oxygen in their structures. The presence of Ce, which is 3.85 wt. %, indicated the successful synthesis of MOFs based on cerium as metallic bridges.

FT-IR: The chemical structures of pristine GO nanosheets and GO/MOF hybridized nanocomposites were compared using FT-IR spectroscopy, shown in FIG. 4. As presented in FIG. 4, the FT-IR spectrum of GO/MOF hybridized nanocomposites is substantially different than that of pristine GO nanosheets. The peaks at 3340, 2920, 1633, and 1035-1065 cm⁻¹ are related to O—H, C—H, C═O, and C—O/C—O—C functionalities of GO nanosheets, which are in good agreement with those in the literature. In the case of GO/MOF hybridized nanocomposites, the intensification of C═O bond at 1610 cm⁻¹ and the appearance of new peaks at 1535 cm⁻¹ (C═O), 1423 cm⁻¹ (O—H deformation vibration), and 650 cm⁻¹ (Ce—O) are good indications for the successful hybridization of MOF nanorods.

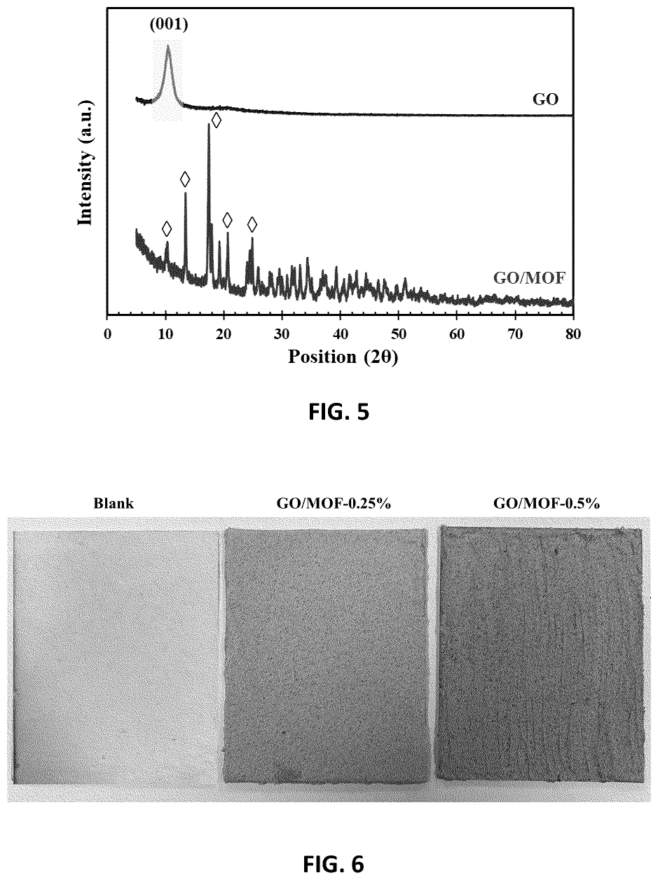

XRD: The XRD patterns of pristine GO nanosheets and GO/MOF hybridized nanocomposites are presented in FIG. 5. The single peak at 10.5 degrees in the pattern of pristine GO nanosheets is linked to (001) carbon atoms of GO nanosheets. The characteristic peaks at 10.2, 13.4, 17.5, 20.7, and 24.9 degrees are attributed to (200), (400), (331), (500), and (731) planes of Ce-based MOFs.

### Characterization of Intumescent Coatings

Before applying the intumescent coatings on mild steel substrates, the surface of the metals was polished with sandpaper numbered 800 to remove impurities. In addition to testing metal with no coating at all, sample polished mild metal steel plates were tested with a pure resin coating, a “blank” intumescent coating, and intumescent coatings including additives of 0.25, 0.5 and 1.5-2 wt. % GO/MOF hybridized nanocomposites, which coatings were applied on the surfaces of the polished mild steel plates with an average thickness of 2 mm (FIG. 6 shows the blank, GO/MOF 0.25 wt. %, and GO/MOF 0.5 wt. % test samples).

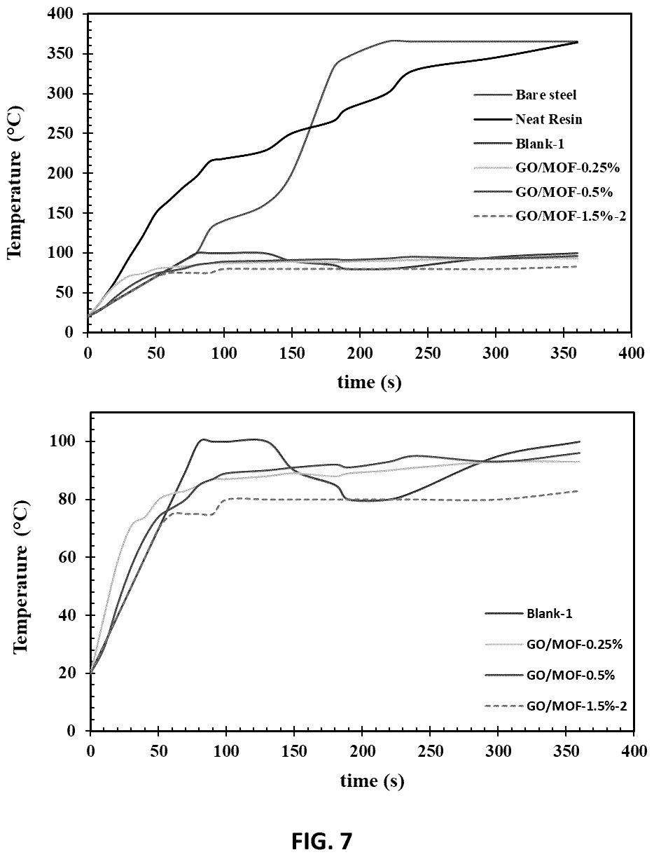

After drying all coated samples at room temperature for 48 hours, the temperature of the metallic substrates was measured as a function of time in the presence of a propane flame. FIG. 7 presents the temperature profile of uncoated and coated samples as a function of time.

The temperature of the mild steel sample with no coating reached 365 degrees C. after 360 seconds. For the test using the neat resin with no flame-retardant additives or GO/MOF, the same temperature was recorded after 360 seconds but a drop in temperature was only detected until 150 degrees C., after which (due to the thermal decomposition of the neat resin) the temperature increased and reached 365 degrees C. It is evident from the results shown in FIG. 7 that in the presence of flame-retardant additives and GO/MOF nanocomposites, a 265 degrees C. difference in the temperature of coated mild steel plates was achieved. The temperatures of coated mild steel reached 100, 96, 93, and 83 degrees C. for the blank coating and the coatings filled with 0.25, 0.5, and 1.5-2 wt. % GO/MOF nanocomposites, respectively. Also, for GO/MOF nanocomposite filled coatings, the temperature profile experienced a plateau trend after 75 seconds; this may be due to the thermal expansion of coatings after 100 seconds, creating a porous ash barrier between substrate and flame.

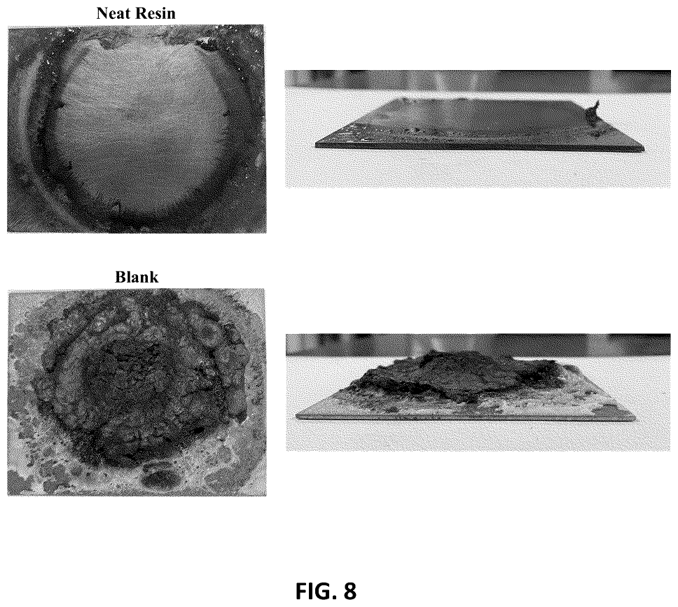

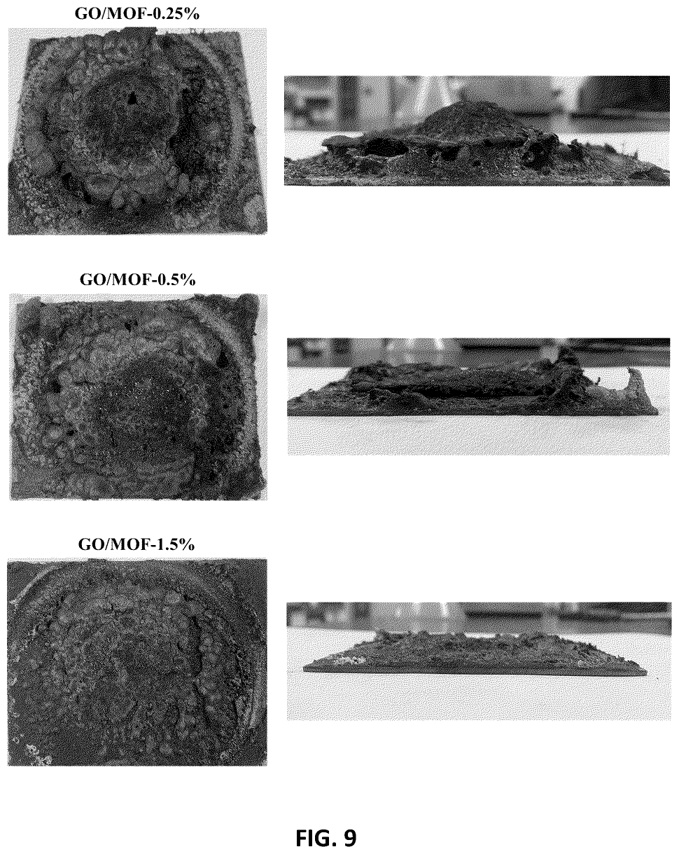

In FIGS. 8 and 9, the appearance of different coatings after the thermal expansion is shown. For the mild steel plate coated with the neat resin, no coating and ash remained at the end of the test, proving the relatively weak flame-retardant performance of the resin alone. The maximum expansion was observed for the intumescent coating filled with 0.25 wt. % GO/MOF nanocomposites, which was around 22 mm. By increasing the loading content of GO/MOF nanocomposites, it appears evident that the expansion index decreased due to the formation of steric hindrance caused by GO/MOF nanocomposites, which would explain why the intumescent coating filled with 1.5 wt. % GO/MOF nanocomposites showed the lowest expansion compared to other coatings. The dimensional and mechanical stabilities of the ash of intumescent coatings filled with GO/MOF nanocomposites were higher than that of the blank coating. Higher dimensional and mechanical stabilities of the ash of flame-retardant coatings may generate better performance and protection.

### Example 2

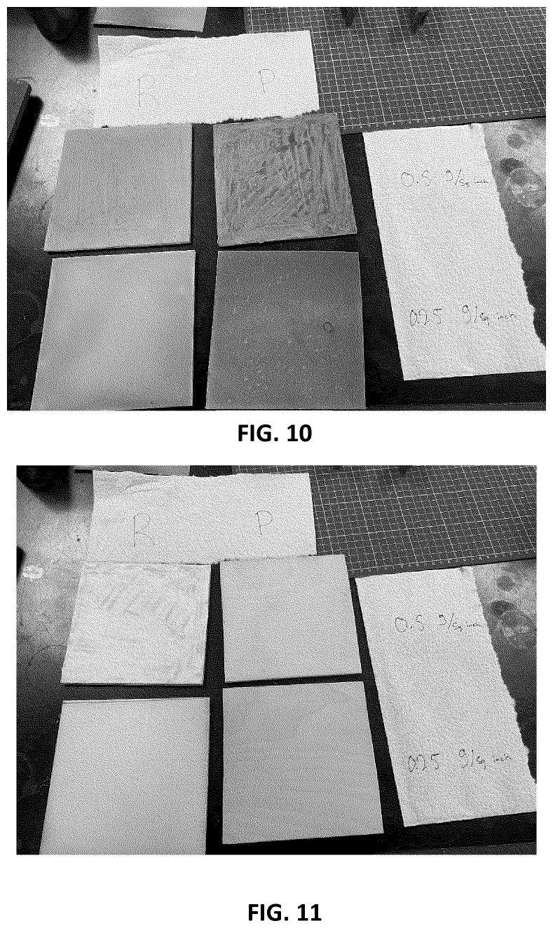

Two different intumescent coating formulations R and P (each prepared with and without GO/MOF enhancement) and one commercially available intumescent paint (INSL-X™ manufactured by Benjamin Moore & Co.) were tested for their ability to protect plywood from a propane torch, as is shown in FIGS. 10 to 15. The influence of a GO/MOF additive was examined by adding it to the two intumescent coating formulations and comparing the results to the same intumescent coating formulations without the additive, as well as comparing it against the INSL-X™ paint. The amount of coating/paint per unit area was varied to demonstrate the effects of coating thickness.

The intumescent formulations R and P were as follows:

TABLE 1
Intumescent formulations R and P.

| | Vinyl | | | | |
|---|---|---|---|---|---|
| | Acrylic | Ammonium | Penta- | | Sodium |
| Sample | Resin | Polyphosphate | erythritol | Melamine | Bicarbonate |
| R | 25% | 37.5% | 18.75% | 18.75% | 1:20 with |
| | | | | | respect to |
| | | | | | the other |
| | | | | | components |
| P | 30% | 35% | 30% | — | 5% |

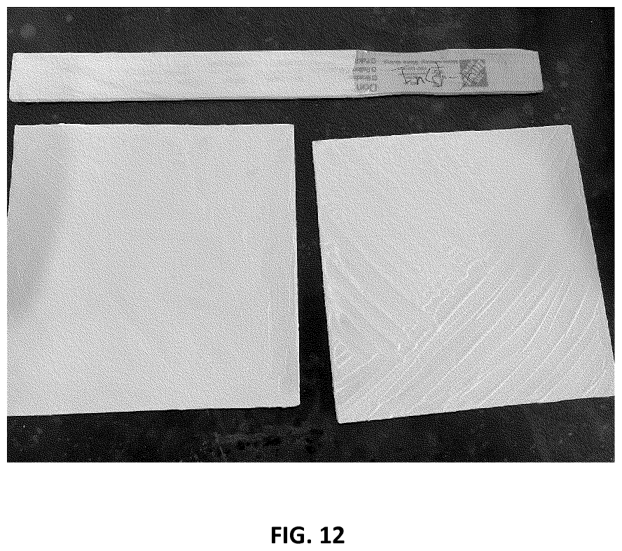

Coatings were painted onto ¼ inch plywood in various amounts. FIG. 10 shows plywood coated with the R and P formulations with GO/MOF additive, FIG. 11 shows plywood coated with the R and P formulations without GO/MOF additive, and FIG. 12 shows plywood coated with the INSL-X™ intumescent paint. Due to uneven painting, the thickness of the coatings was not measured, but the amount of active ingredients (anything other than water, the latter having been applied drop by drop to the coatings until they were well dispersed and the coatings thin enough to paint the plywood) applied to the wood was measured. For the R and P coatings, they were applied at 0.25 g/sq. inch and 0.5 g/sq. inch of active ingredients. INSL-X™ was tested and was applied at 0.175 g/sq. inch (as specified in the instructions on the product can) and 0.35 g/sq. inch (double the recommended thickness). GO/MFO was added to the R and P coatings at 0.2 wt % and tested along with the same R and P coatings without GO/MFO, to compare the performance with and without GO/MFO.

After application to the plywood, the samples were left to dry at least 24 hours. The coated plywood was then placed coating-side-down on a ring clamp 6 cm from the top of the propane torch. The torch was provided with adjustable gas and air inlets, and all samples were tested with the air inlet fully open and gas inlet half open. The flame had a strong blue colour, like a blowtorch flame.

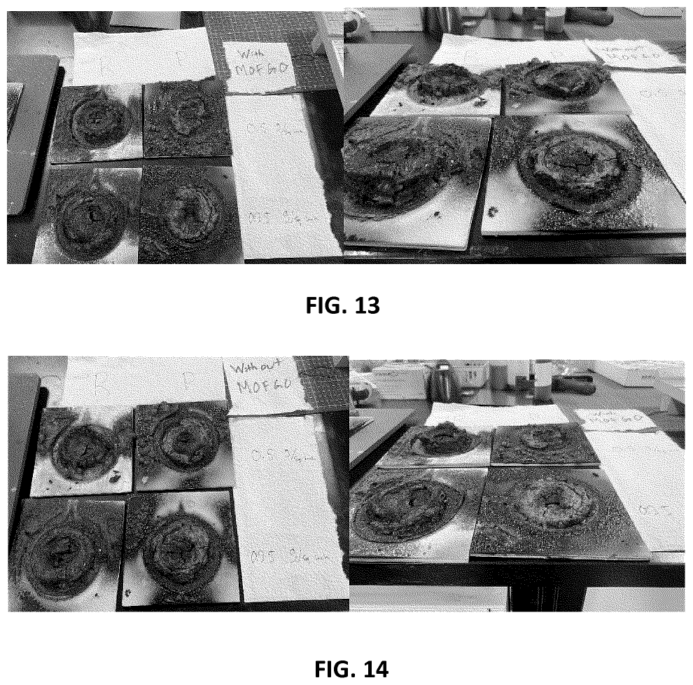

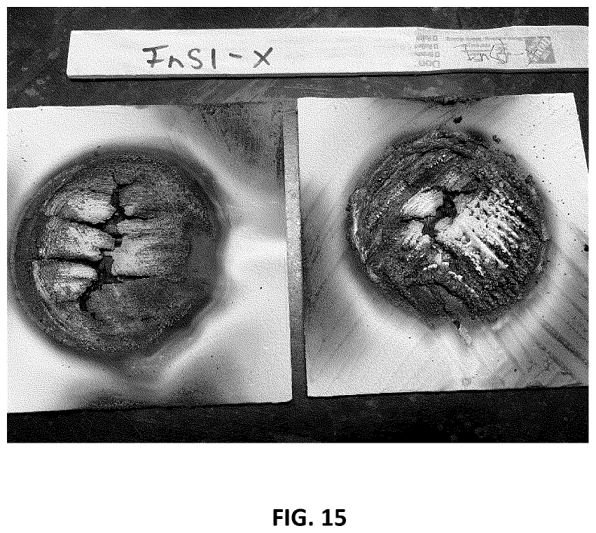

The coated plywood was exposed in each case to the propane torch flame until a crack or hole formed in the back side of the plywood. To begin testing, the torch was lit and the sample was placed on the ring clamp with the flame centered on the sample, and the timer was started. The test concluded in each case once there was a visible crack/hole in the back side of the plywood. The time it took to achieve visible formation of the crack/hole was recorded and used as a quantitative measure of coating performance. FIG. 13 shows the plywood coated with R and P formulations (with the GO/MOF additive) after crack/hole formation, FIG. 14 shows the plywood coated with R and P formulations (without the GO/MOF additive) after crack/hole formation, and FIG. 15 shows the plywood coated with the INSL-X™ paint after crack/hole formation. The results are shown in Table 2 (“MOFGO” indicates the GO/MFO additive).

TABLE 2
Test results of flame application to coated plywood samples.

| | | Time | time | % increase | % increase |
|---|---|---|---|---|---|
| | g/sq inch | (mm:ss) | (s) | wrt. R 0.25 | wrt. R 0.5 |
| R | 0.25 | 28:44 | 1724 | 0 | −20 |
| | 0.5 | 36:00 | 2160 | 25 | 0 |
| R w MOFGO | 0.25 | 34:17 | 2057 | 19 | −5 |
| | 0.5 | 58:28 | 3508 | 103 | 62 |
| | | | | % increase | % increase |
| | | | | wrt. P 0.25 | wrt. P 0.5 |
| P | 0.25 | 13:01 | 781 | 0 | −43 |
| | 0.5 | 23:02 | 1382 | 77 | 0 |
| P w MOFGO | 0.25 | 15:56 | 956 | 22 | −31 |
| | 0.5 | 33:43 | 2023 | 159 | 46 |
| Insl-X | 0.175 | 5:05 | 305 | | |
| | 0.35 | 8:53 | 533 | | |

The tests were conducted to demonstrate the potential effects of the GO/MFO additives in the intumescent coatings compared to coating without the additives. Comparing the different formulations with and without GO/MFO demonstrated that there is a consistent increase in burn time for the coatings that do contain the GO/MFO additive. The 0.25 g/sq. inch coatings had 19-22% increase in burn time compared to the same formulation without GO/MFO. The 0.5 g/sq. inch coatings had 46-62% increase in burn time compared to the same formulation without GO/MFO. Interestingly, the burn time of sample R 0.5 g/sq. inch and R with GO/MFO 0.25 g/sq. inch was roughly the same, suggesting that for this case adding 0.2 wt % GO/MFO has the same effect as doubling the amount of coating on the sample.

Through observation, the GO/MFO had little to no effect on the expansion of the char. It did appear to increase the thermal stability of the char, apparent by the increased lifespan of the char when exposed to flame. This is likely the cause of the increased burn time for all samples containing GO/MFO. This is important since the char fails by eventually burning away, leaving a char that resembles a crater, as can be seen in FIGS. 13 to 15.

INSL-X™ had the poorest performance of the tested samples, supporting the conclusion that the R and P coatings without GO/MFO are at least as effective as one product on the market, while the results supported the increased effectiveness of the GO/MFO enhanced samples. In the thin coatings, GO/MFO increased the time it took until the wood failed (burn time) by 19-22% compared to the same formulation without GO/MFO, while in the thick coatings, GO/MFO increased the burn time by 46-62%.

The foregoing is considered as illustrative only of the principles of the present invention. The scope of the claims should not be limited by the exemplary embodiments set forth in the foregoing, but should be given the broadest interpretation consistent with the specification as a whole.

1. A nanocomposite composition comprising graphene oxide nanosheets hybridized with metallic organic frameworks.

2. The composition of claim 1, wherein the metallic organic framework comprises nanorods grafted on the surface and in between the graphene oxide nanosheets.

3. The composition of claim 1, wherein tannic acid is further functionalized to the graphene oxide nanosheets.

4. The composition of claim 1, comprising a ratio of graphene oxide nanosheets to metallic organic frameworks of 1:1 to 1:3.

5. The composition of claim 1 formed by adding Ce³⁺ in concentrations of 4.5-9 g per 1 g of the graphene oxide nanosheets at pH 10 under stirring for 1-3 hours.

6. An intumescent coating composition comprising a hybridized graphene oxide and metallic organic framework nanocomposite additive, wherein the additive is formed from graphene oxide nanosheets and metallic organic framework nanorods.

7. The composition of claim 6 comprising melamine-ammonium polyphosphate, pentaerythritol, acrylic resin/solvent, tannic acid, and the additive.

8. The composition of claim 7 wherein the composition comprises 50-60 wt. % of the melamine-ammonium polyphosphate, 5-10 wt. % of the pentaerythritol, 10-20 wt. % of the acrylic resin/solvent, 2-5 wt. % of the tannic acid, and 0.1-1.5 wt. % of the additive.

9. The composition of claim 6 wherein the graphene oxide nanosheets have an average lateral size of 0.5-20 μm.

10. The composition of claim 6 wherein the metallic organic framework nanorods are about 80-180 nm in average diameter.

11. The composition of claim 6 wherein the additive is blended into a polymer or an elastomer.

12. The composition of claim 6 further comprising: the additive; ammonium polyphosphate; and a material selected from the group consisting of graphite, expandable graphite, expanded graphite and silicon.

13. A method of manufacturing an intumescent coating composition comprising the steps of:
a. forming a graphite powder suspension;
b. adding KMnO₄ to the graphite powder suspension to form a mixture while decreasing the temperature of the mixture;
c. adding distilled water to the mixture;
d. adding H₂O₂ to the mixture to form graphene oxide nanosheets in a nanosheet suspension;
e. washing the graphene oxide nanosheet suspension a plurality of times with 1 M HCl and a plurality of times with an 8:2 v/v water/ethanol mixture to obtain washed graphene oxide nanosheets;
f. dispersing the washed graphene oxide nanosheets in deionized water to form a GO/DI suspension;
g. adding CeNO₃ to the GO/DI suspension to form a GO/DI/Ce³⁺ suspension;
h. dissolving benzene-1,3,5-tricarboxylic acid in ethanol to form a solution;
i. adding the solution to the GO/DI/Ce³⁺ suspension to form hybridized graphene oxide and metallic organic framework nanocomposites;
j. collecting the hybridized graphene oxide and metallic organic framework nanocomposites and exchanging the deionized water and the ethanol in the hybridized graphene oxide and metallic organic framework nanocomposites with xylene; and
k. mixing the washed hybridized graphene oxide and metallic organic framework nanocomposites into an intumescent base material.

14. The method of claim 13 wherein the graphite powder suspension is formed from graphite powder and a solution of H₂SO₄ and H₃PO₄.

15. The method of claim 13 wherein the graphite powder suspension is sonicated in a bath sonicator between steps a. and b.

16. The method of claim 13 wherein the mixture of step b. is stirred, followed by bath sonication.

17. The method of claim 13 wherein the distilled water is at 2-5 degrees C.

18. The method of claim 13 where bath sonication after step d. is used to accelerate separation of the graphene oxide nanosheets.

19. The method of claim 13 further comprising bath sonication between the HCl and water/ethanol mixture washings to accelerate impurity removal between the graphene oxide nanosheets.

20. The method of claim 13 wherein step j. comprises washing the hybridized graphene oxide and metallic organic framework nanocomposites with xylene via centrifugation.

21. The method of claim 13 wherein the intumescent base material comprises melamine-ammonium polyphosphate, pentaerythritol, acrylic resin/solvent, and tannic acid.

22. Use of an intumescent composition comprising a hybridized graphene oxide and metallic organic framework nanocomposite additive as a fire-retardant coating for a substrate, wherein the additive is formed from graphene oxide nanosheets and metallic organic framework nanorods.

23. The use of claim 22 wherein the substrate is selected from metal, polymer nanocomposites, and wood.

24. The use of claim 22 wherein the composition is applied to the substrate using a film applicator.

25. The use of claim 22 wherein the composition is allowed to dry on the substrate before exposing the substrate to fire.

26. The use of claim 22 wherein the composition comprises a metallic organic framework, wherein porosity of the metallic organic framework allows adsorption of combustion gases.

27. The use of claim 22 wherein the composition comprises graphene oxide, wherein the graphene oxide is reduced to reduced graphene oxide.

28. The use of claim 27 wherein the reducing of the graphene oxide in the presence of flames generates water and vapor thereby reducing spread of the flames, absorbs energy through conversion of the water to steam, and due to the steam increases volume of char formed.

29. The use of claim 22 wherein the composition comprises graphene oxide, wherein the graphene oxide enhances mechanical performance of char thereby extending fire barrier duration.
